(19) United States
(12) Patent Application Publication
(10) Pub. No.: US 2010/0054833 A1
(43) Pub. Date: Mar. 4, 2010

(54) DOCUMENT FEEDER AND IMAGE FORMING APPARATUS INCLUDING THE SAME

(75) Inventor: Katsuhiko Hanamoto, Osaka (JP)

Correspondence Address: K&L Gates LLP, P.O. Box 1135, CHICAGO, IL, 60690, US

(73) Assignee: KYOCERA MITA CORPORATION, Osaka (JP)

(21) Appl. No.: 12/468,652

(22) Filed: May 19, 2009

(30) Foreign Application Priority Data
Aug. 26, 2008 (JP) 2008-216861

(51) Int. Cl. G03G 15/00

(52) U.S. Cl. 399/374

(57) ABSTRACT

A document feeder includes a document feeding means which feeds document sheets stacked on a document tray one at a time, a registration means which feeds each document sheet to an image reading position, a re-feeding means which receives the document sheet after a first side thereof is read and re-feeds the document sheet to allow a second side to be read, a discharging means which discharges the document sheet, a first drive transmission mechanism which transmits a driving force to the document feeding means and the re-feeding means, and a second drive transmission mechanism which transmits the driving force to the registration means and the discharging means. The driving force is transmitted to the first and second drive transmission mechanisms from a single motor. A clutch is provided upstream of the document feeding means in a direction in which the driving force is transmitted in the first drive transmission mechanism.

### INCORPORATION BY REFERENCE

This application is based upon and claims the benefit of priority from the corresponding Japanese Patent application No. 2008-216861, filed Aug. 26, 2008, the entire contents of which are incorporated herein by reference.

### BACKGROUND

1. Field of the Invention

The present invention relates to a document feeder which feeds document sheets one by one from a stack of documents in a digital copy machine or the like, and an image forming apparatus including the document feeder.

2. Description of the Related Art

An image reading device mounted in a copy machine using electrophotography or the like includes an automatic document feeder. The automatic document feeder successively feeds document sheets to a document table to allow the documents to be read, and then removes the documents from the document table after the reading operation is finished. The image reading device is capable of performing two kinds of reading methods: a sheet-through method; and a document stationary method. In the sheet-through method, the document sheets are automatically fed by the document feeder as described above while a document retainer is closed. In the sheet stationary method, an operator places the document sheets one by one on the document table (contact glass) by opening and closing the document retainer each time the reading operation is performed.

Generally, driving systems that are used in the document feeder are driven by two or more motors. However, the cost of the device increases with the number of motors, and a complex control method is required since it is necessary to individually control each of the motors. In addition, power consumption also increases when a plurality of motors are used. Moreover, the size of the space for accommodating components including the motors and the total weight thereof also increases.

Therefore, various methods for driving a plurality of driving systems using a single motor have been proposed. For example, an image reading device is known which includes two reading units (a movable reading scanner and a contact image sensor), a document pickup, a first feeding system which performs a feeding operation, a second feeding system provided near the reading units, a first drive transmission unit which transmits a driving force to the first feeding system, and a second drive transmission unit which transmits a driving force to the second feeding system. The first drive transmission unit and the second drive transmission unit are driven by a single motor. On the other hand, it is also known to use a sheet feeding device in which a sheet feeding unit and a registration unit are driven by a single driving unit.

However, in the above-described structures, not all of the driving systems for feeding the document sheets, re-feeding the document sheets in a duplex reading operation, and discharging the document sheets can be driven by a single motor. Therefore, the requirements of users who work in, for example, a so-called small-office/home-office (SOHO), cannot be satisfied.

### SUMMARY

The present invention provides a document feeder capable of driving all of the driving systems for feeding document sheets, re-feeding the document sheets in a duplex reading operation, and discharging the document sheets with a single motor without degrading the functions and performance. The present invention also provides an image forming apparatus including the document feeder.

According to an embodiment of the present invention, a document feeder is provided that includes: a document feeding means which feeds document sheets stacked on a document tray one at a time; a registration means which receives each document sheet from the document feeding means and feeds the document sheet to an image reading position at a predetermined timing; a re-feeding means which receives the document sheet after the image on the first side of the document sheet is read at the image reading position and which re-feeds the document sheet to the registration means in a manner to allow the image on the second side of the document sheet to be read; a discharging means which discharges the document sheet after an image reading operation performed at the image reading position is completed; a first drive transmission mechanism; and a second drive transmission mechanism. A driving force is transmitted to the first drive transmission mechanism and the second drive transmission mechanism from a drive output shaft of a single motor. A clutch is provided in the first drive transmission mechanism at a position upstream of the document feeding means in a direction in which the driving force is transmitted.

Additional features and advantages are described herein, and will be apparent from the following Detailed Description and the figures.

### BRIEF DESCRIPTION OF THE FIGURES

In the accompanying drawings:

FIG. 1 is a sectional side view illustrating the overall structure of an image forming apparatus including a document feeder according to an embodiment of the present invention;

FIG. 2 is a sectional side view illustrating the inner structure of the document feeder according to an embodiment of the present invention in the case where a single-sided document sheet is read;

FIG. 3 is a sectional side view illustrating the inner structure of the document feeder according to an embodiment of the present invention in the case where the second side of a double-sided document sheet is read;

FIG. 4 is a perspective view of a drive transmission system included in the document feeder according to an embodiment of the present invention;

FIG. 5 is a side view of the drive transmission system illustrating the manner in which a driving force is transmitted in a primary feeding operation or in a re-feeding operation in which a document sheet is fed from a reverse tray in an embodiment of the present invention; and

FIG. 6 is a side view of the drive transmission system illustrating the manner in which a driving force is transmitted by the drive transmission system in a secondary feeding operation, a sheet discharging operation, or an operation of feeding a document sheet to a reverse tray in an embodiment of the present invention.

### DETAILED DESCRIPTION

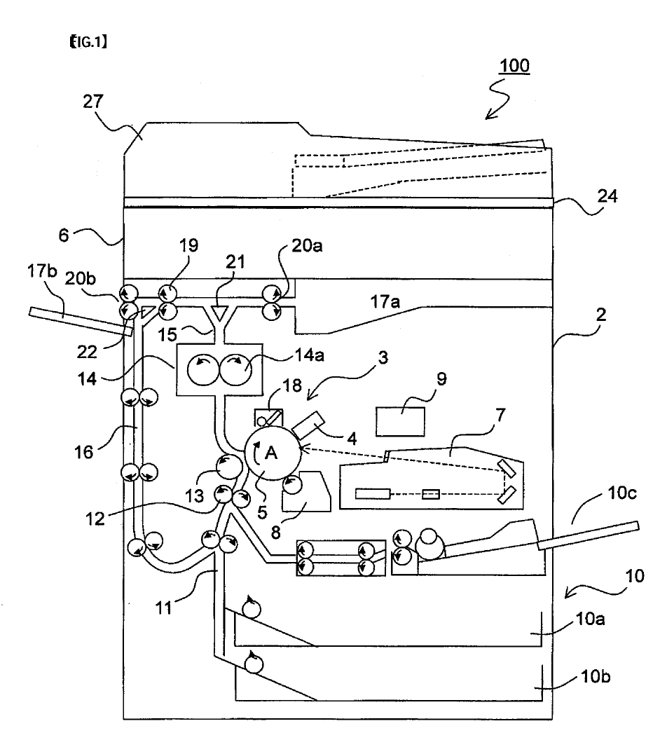

An embodiment of the present invention will now be described with reference to the drawings. FIG. 1 is a schematic diagram illustrating an image forming apparatus including a document feeder. Referring to FIG. 1, when an image forming apparatus (digital multifunction machine) 100 performs a copying operation, first, an image reading device 6 converts data of an image on a document sheet into an image signal. Then, in an image forming section 3 provided in a main body 2, a photosensitive drum 5, which rotates in a direction shown by arrow A in FIG. 1, is uniformly charged by a charging unit 4. The thus-charged photosensitive drum 5 is irradiated with a laser beam emitted from an exposure unit (laser scanning unit) 7, which is controlled based on the document image data obtained by the image reading device 6. Thus, an electrostatic latent image is formed on the photosensitive drum 5. Then, developer (hereinafter referred to as toner) is supplied by a developing unit 8 and is caused to adhere to the electrostatic latent image, so that a toner image is formed on the photosensitive drum 5. The toner is supplied to the developing unit 8 from a toner container 9.

A sheet of paper is fed toward the photosensitive drum 5, on which the toner image is formed as described above, from a sheet feeding mechanism 10 which stores stacks of paper. More specifically, the sheet is fed toward the image forming section 3 by a sheet-conveying mechanism through a sheet conveying path 11 and a pair of registration rollers 12. Then, the toner image formed on the surface of the photosensitive drum 5 is transferred onto the sheet by a transfer roller (image transferring unit) 13. Then, the sheet on which the toner image is transferred is separated from the photosensitive drum 5 and is fed to a fixing unit 14 including a pair of fixing rollers 14a. The toner image is fixed by the fixing unit 14. The sheet passes through the fixing unit 14 and is fed to a sheet conveying path 15, which branches into a plurality of paths extending in different directions. The direction in which the sheet is fed is set by path-switching mechanisms 21 and 22 including a plurality of path switching guides which are located at the branching points of the sheet conveying path 15. The sheet is directly discharged by a sheet discharging unit, or is discharged after being fed to a sheet conveying path 16 and subjected to a duplex copying operation. The sheet discharging unit includes a first output tray 17a and a second output tray 17b.

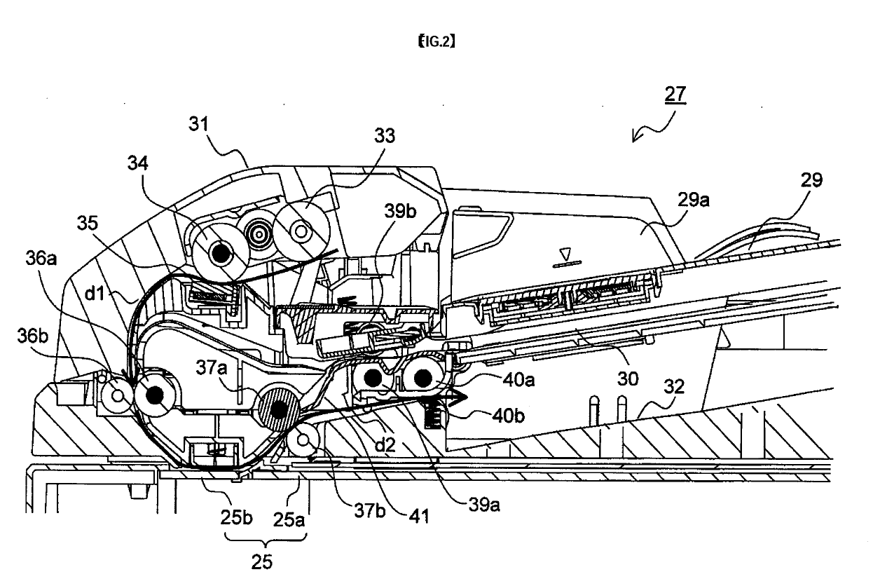

Although not illustrated in the figure, an eraser lamp for removing a residual charge on the surface of the photosensitive drum 5 is located downstream of a cleaning device 18 in the rotating direction of the photosensitive drum 5. The sheet feeding mechanism 10 includes a plurality of paper cassettes 10a and 10b which are detachably attached to the main body 2 and which each store sheets of paper, and a stack bypass (manual feed tray) 10c disposed above the paper cassettes 10a and 10b. The sheet feeding mechanism 10 is connected to the image forming section 3 by the sheet conveying path 11. A platen (document retainer) 24, which retains a document sheet placed on a contact glass 25 (see FIG. 2) included in the image reading device 6, is located on a top surface of the main body 2. The platen 24 can be opened and closed. A document feeder 27 for feeding the document sheet is located on the platen 24.

The sheet conveying path 15 is divided into two paths which extend to the right and left at a position downstream of the fixing rollers 14a. One of the paths (the path extending right in FIG. 1) is connected to the first output tray 17a. The other path (the path extending left in FIG. 1) extends through a pair of conveying rollers 19 and is divided into two paths: an upper path and a lower path. One of these paths (the upper path in FIG. 1) is connected to the second output tray 17b. The other path (the lower path in FIG. 1) is connected to the sheet conveying path 16.

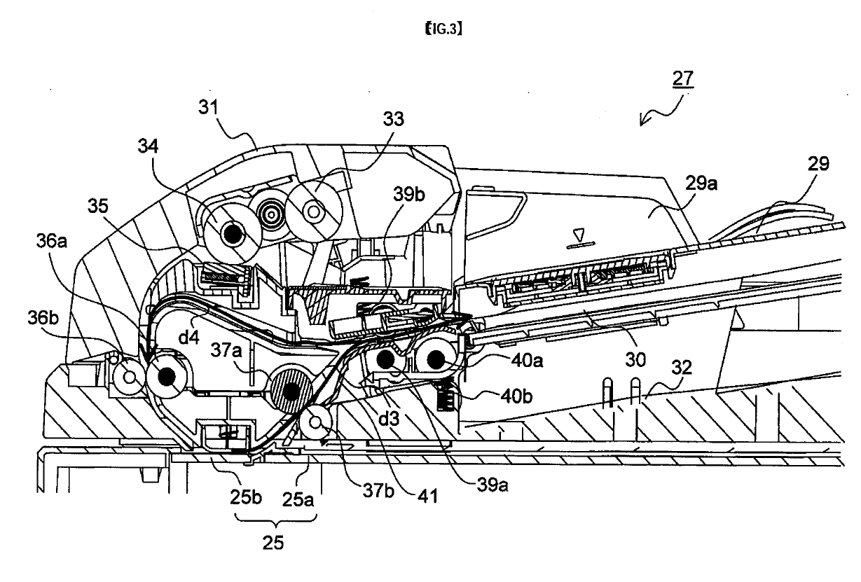

FIGS. 2 and 3 are sectional side views illustrating the inner structure of the document feeder 27. FIG. 2 illustrates a feeding path used in the case where a single-sided document sheet is read, and FIG. 3 illustrates the feeding path used in the case where a second side of a double-sided document sheet is read after a first side thereof. The document feeder 27 includes a document tray 29 and a reverse tray 30. The document tray 29 is provided with a document guide 29a for aligning a plurality of document sheets on the document tray 29. The reverse tray 30 is located below the document tray 29. The document tray 29 and the reverse tray 30 are attached to a frame of the document feeder 27. In addition, a cover member 31 is attached to the frame of the document feeder 27 such that the cover member 31 can be opened and closed by pivoting about an end thereof (lower left end in the figure) with respect to the frame of the document feeder 27. A document output tray 32, which is integrally formed with a portion of the platen 24 (see FIG. 1) at the top surface thereof, is located below the reverse tray 30.

The document feeder 27 located in the cover member 31 includes a document feeding unit. The document feeding unit includes a pickup roller 33, a sheet-feeding roller 34, a separation pad 35, a pair of registration rollers 36a and 36b, a pair of conveying rollers 37a and 37b, a pair of reversing rollers 39a and 39b, and a pair of discharging rollers 40a and 40b. An arm (not illustrated) is pivotable about a rotating shaft of the sheet-feeding roller 34 and the pickup roller 33 is attached to the free end of the arm. In the process of feeding the document sheets from the document tray 29, the sheet-feeding roller 34 is rotated such that the arm is pivoted downward. Accordingly, the pickup roller 33 moves from a standby position (home position) to a sheet feed position and is pressed against the top surface of the topmost document sheet. After the document sheet is fed, the sheet-feeding roller 34 is rotated in the reverse direction so as to move the arm upward. Therefore, the pickup roller 33 moves from the sheet feed position to the home position.

The document feeding unit includes a first feeding path d1 which extends from the sheet-feeding roller 34 to the registration rollers 36a and 36b, a second feeding path d2 which extends from the registration rollers 36a and 36b to the document output tray 32 through an automatic reading glass 25b, a third feeding path d3 which extends from the automatic reading glass 25b to the reverse tray 30, and a fourth feeding path d4 which extends from the reverse tray 30 to the registration rollers 36a and 36b. The feeding paths d1 to d4 are exposed when the cover member 31 is opened. If a jam occurs in one of the feeding paths d1 to d4, the jammed sheet can be removed by exposing the feeding paths d1 to d4. A plurality of sheet detection sensors (not shown), for detecting the presence or absence of the sheet, such as a sheet feed sensor and a sheet discharging sensor, are located in the feeding paths d1 to d4 at suitable positions.

The contact glass 25 includes a manual document reading glass 25a and the automatic reading glass 25b. The contact glass 25 also includes a white plate (not shown) and a document pressing member (not shown). The white plate is located so as to face the automatic reading glass 25b (at an image reading position) and is used for correcting shading. The document pressing member is located above the white plate and is used to press the white plate against the manual document reading glass 25a.

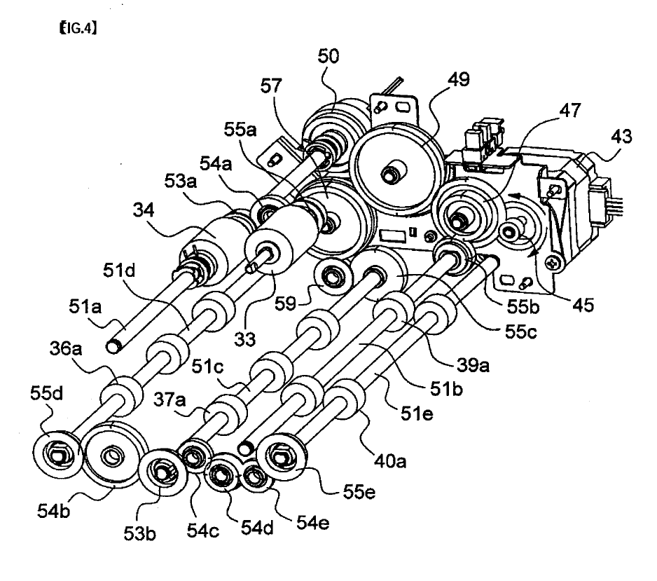

A document feeding operation performed in the document feeder 27 by the sheet-through method will now be described. First, the situation wherein single-sided document sheets are read will be described with reference to FIG. 2. First, the document sheets are set on the document tray 29 such that the image sides thereof face upward. Then, when the copy start button (not shown) on an operation panel (not shown) of the image forming apparatus 100 is turned on, a motor 43 (see FIG. 4), which serves as the drive source, starts to rotate. When the motor 43 rotates, the sheet-feeding roller 34 and the pickup roller 33 also start to rotate in such a direction that the document sheets can be fed. In addition, the pickup roller 33 moves to the sheet feed position and is pressed against the top surface of the topmost document sheet at a predetermined pressure (sheet feeding pressure).

Normally, a plurality of document sheets at the top of the stack of document sheets on the document tray 29 are fed together by the pickup roller 33 to a nip section formed by the sheet-feeding roller 34 and the separation pad 35. Then, the topmost document sheet is separated from the other document sheets by the separation pad 35. The thus-separated document sheet is fed to the registration rollers 36a and 36b along the first feeding path d1 (primary feeding). The thus-conveyed document sheet is stopped so that the leading edge thereof is nipped between the registration rollers 36a and 36b and a front section of the document sheet thereof is bent.

When a predetermined time elapses after the completion of the primary feeding, the secondary feeding is started. More specifically, the motor 43 (see FIG. 4) is driven so as to rotate the registration rollers 36a and 36b. The document sheet is fed to the automatic reading glass 25b from the registration rollers 36a and 36b along the second feeding path d2. Then, the document sheet is fed to the discharging rollers 40a and 40b through the conveying rollers 37a and 37b, and is discharged onto the document output tray 32 by the discharging rollers 40a and 40b. At this time, the trailing edge of the document sheet is detected by a sheet discharging sensor (not shown). Thus, the completion of an image reading operation for the document sheet is detected.

The sheet discharging sensor counts the number of document sheets each time the document feeding operation is completed. If it detects that there are more document sheets to be fed, the above-described document feeding operation is performed for the second sheet and following document sheets. When the document sheet passes the automatic reading glass 25b, the document sheet is conveyed while being gently pressed against the automatic reading glass 25b. At this time, the image on the document sheet is read by the image reading device 6 (see FIG. 1) through the automatic reading glass 25b.

Next, the situation in which double-sided document sheets are read will be described with reference to FIG. 3. First, the document sheets are set on the document tray 29 such that first sides (front sides) thereof face upward. Then, when the copy start button (not shown) on the operation panel (not shown) of the image forming apparatus 100 is turned on, the pickup roller 33 and the sheet-feeding roller 34 are rotated. Then, similar to the situation in which single-sided document sheets are read, primary feeding and secondary feeding are performed. Thus, the first side of the first document sheet is read.

The image on the first side of the document sheet is read when the document sheet passes the automatic reading glass 25b. Then, as illustrated in FIG. 3, a guide member 41 is moved downward so that the document sheet is guided to the third feeding path d3. Accordingly, the document sheet is temporarily discharged onto the reverse tray 30 by the reversing rollers 39a and 39b. Then, the reversing rollers 39a and 39b are temporarily stopped while the trailing edge of the document sheet is nipped between the reversing rollers 39a and 39b. Then, the guide member 41 is returned to the position shown in FIG. 2, and the reversing rollers 39a and 39b are rotated in the reverse direction. Therefore, the document sheet is fed along the fourth feeding path d4 to a position upstream of the registration rollers 36a and 36b again while the second side (back side) of the document sheet faces upward. The image on the second side of the document sheet is then read through the automatic reading glass 25b. Then, the document sheet is fed along the second feeding path d2 (see FIG. 2) to the discharging rollers 40a and 40b through the conveying rollers 37a and 37b, and is discharged onto the document output tray 32.

FIG. 4 is a perspective view of the drive transmission system included in the document feeder. For simplifying the drawing, with respect to the registration rollers 36a and 36b, the conveying rollers 37a and 37b, the reversing rollers 39a and 39b, and the discharging rollers 40a and 40b, only the driving rollers 36a, 37a, 39a, and 40a are shown. In the document feeder according to an embodiment of the present invention, the pickup roller 33, the sheet-feeding roller 34, the registration roller 36a, the conveying roller 37a, the reversing roller 39a, and the discharging roller 40a are driven by a single motor 43. A clutch gear 50 including an electromagnetic clutch is provided to transmit or cut off the driving force depending on whether or not current is supplied thereto. In addition, a one-way gear 59 is provided to transmit the driving force only in a predetermined rotational direction (clockwise in FIG. 4).

The driving force of the motor 43 is transmitted to the sheet-feeding roller 34 through a double gear 47, which is connected to a pinion gear 45 fixed to a drive output shaft of the motor 43, a double gear 49, and the clutch gear 50. In addition, the driving force is also transmitted to the pickup roller 33 through a drive output gear 53a, which is fixed to a shaft 51a on which the sheet-feeding roller 34 is provided, an idle gear 54a, and a drive input gear 55a. In addition, the driving force of the motor 43 is also transmitted to the reversing roller 39a through the double gear 47 and a drive input gear 55b. The double gears 47 and 49, the clutch gear 50, the drive output gear 53a, the idle gear 54a, and the drive input gears 55a and 55b form a first drive transmission mechanism which transmits the driving force of the motor 43 to the pickup roller 33, the sheet-feeding roller 34, and the reversing roller 39a.

The driving force of the motor 43 is also transmitted to the conveying roller 37a through a large gear 57, which is connected to the double gear 49, the one-way gear 59, and a drive input gear 55c. The driving force of the motor 43 is also transmitted to the registration roller 36a through a drive output gear 53b, which is fixed to a shaft 51c of the conveying roller 37a, an idle gear 54b, and a drive input gear 55d, and to the discharging roller 40a through the drive output gear 53b, an idle gears 54c, 54d, and 54e, and a drive input gear 55e. The large gear 57, the one-way gear 59, the drive input gear 55c, the drive output gear 53b, the idle gears 54b to 54e, and the drive input gears 55d and 55e form a second drive transmission mechanism which transmits the driving force of the motor 43 to the registration roller 36a, the conveying roller 37a, and the discharging roller 40a.

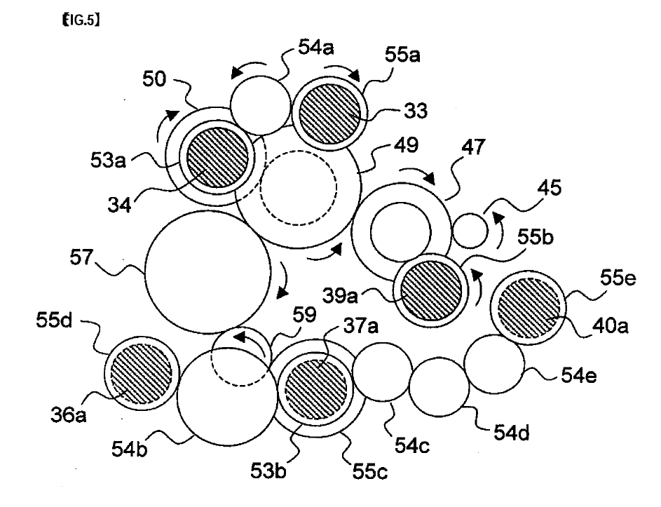

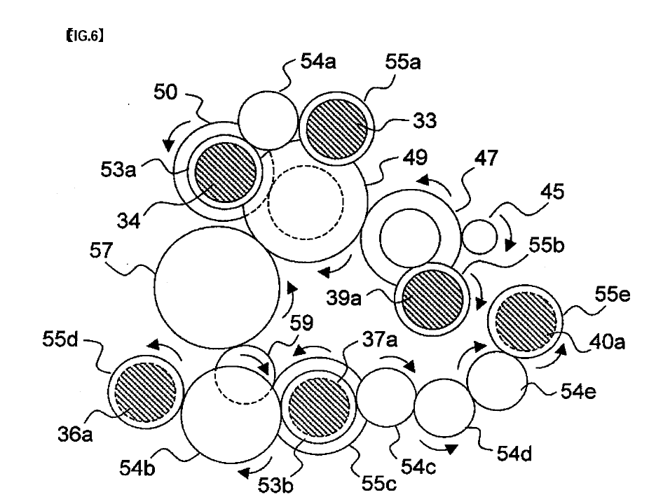

FIGS. 5 and 6 are diagrams illustrating the manner in which the driving force is transmitted by the drive transmission system shown in FIG. 4. FIG. 5 illustrates the manner in which the driving force is transmitted while the first feeding path d1 or the fourth feeding path d4 is being used. FIG. 6 illustrates the manner in which the driving force is transmitted while the second feeding path d2 or the third feeding path d3 is being used. The drive transmission system of the document feeder according to an embodiment of the present invention will now be described in detail with reference to FIGS. 4 to 6.

In the process of feeding the document sheet along the first feeding path d1 (primary feeding), as shown in FIG. 5, the driving force is transmitted to the double gear 47 by rotating the pinion gear 45 fixed to the drive output shaft of the motor 43 in the direction shown by the arrow (counterclockwise). The driving force is transmitted to the clutch gear 50 through the double gears 47 and 49, and the clutch gear 50 is rotated in the direction shown by the arrow (clockwise).

Accordingly, the sheet-feeding roller 34, which is connected to the clutch gear 50 by the shaft 51a, rotates clockwise (in the sheet-feeding direction). The drive output gear 53a is fixed to the shaft 51a, and the drive input gear 55a of the pickup roller 33 is connected to the drive output gear 53a by the idle gear 54a. Therefore, the pickup roller 33 also rotates clockwise (in the sheet-feeding direction).

The one-way gear 59 receives a rotating force in the direction shown by the arrow (counterclockwise) from the large gear 57, which is connected to the double gear 49. However, the one-way gear 59 slips because the one-way gear 59 is capable of transmitting a driving force only when the one-way gear 59 rotates clockwise. Therefore, the drive input gear 55c does not rotate. Since the drive input gear 55c does not rotate, the driving force of the motor 43 is not transmitted to any of the registration roller 36a, the conveying roller 37a, or the discharging roller 40a. Accordingly, the document sheet fed along the first feeding path d1 stops at the registration rollers 36a and 36b. Since the driving force of the motor 43 is also transmitted to the reversing roller 39a through the double gear 47, the drive input gear 55b, and a shaft 51b, the reversing roller 39a also rotates in the direction shown by the arrow (counterclockwise). However, since the document sheet stops when the document sheet comes into contact with the registration rollers 36a and 36b, the document feeding operation is not affected by the rotation of the reversing roller 39a.

In the process of feeding the document sheet along the second feeding path d2 (secondary feeding), the motor 43 is rotated in a direction opposite to that of the primary feeding. Accordingly, as shown in FIG. 6, the driving force is transmitted to the double gear 47 from the pinion gear 45 which rotates in the direction shown by the arrow (clockwise). The driving force is transmitted to the one-way gear 59 through the double gears 47 and 49 and the large gear 57. Since the one-way gear 59 is rotated in the direction shown by the arrow (clockwise), the driving force is transmitted to the drive input gear 55c. Therefore, the drive input gear 55c rotates in the direction shown by the arrow (counterclockwise). Accordingly, the conveying roller 37a, which is connected to the drive input gear 55c by the shaft 51c, also rotates counterclockwise (in the sheet-conveying direction).

In addition, the drive output gear 53b which is fixed to the shaft 51c at an end opposite to the drive input gear 55c is connected to the drive input gear 55d through the idle gear 54b. The drive output gear 53b is also connected to the drive input gear 55e through the idle gears 54c to 54e. The drive input gear 55d is connected to the registration roller 36a through a shaft 51d, and the drive input gear 55e is connected to the discharging roller 40a through a shaft 51e. Therefore, similar to the conveying roller 37a, the registration roller 36a and the discharging roller 40a also rotate counterclockwise (sheet-conveying direction).

Therefore, when the motor 43 is rotated in the reverse direction, the document sheet stops at the registration rollers 36a and 36b is fed along the second feeding path d2 through the automatic reading glass 25b, the conveying rollers 37a and 37b, the discharging rollers 40a and 40b, and is discharged onto the document output tray 32. At this time, the clutch gear 50 is turned off so that a driving force is not transmitted to either the sheet-feeding roller 34 or the pickup roller 33. Therefore, the document sheet that follows is not fed from the document tray 29.

In the situation where a second side of a double-sided document sheet is to be read, the guide member 41 (see FIG. 3) is moved downward. Accordingly, the document sheet which passes through the conveying rollers 37a and 37b after the image on the first side thereof is read is fed toward the reversing rollers 39a and 39b. At this time, as shown in FIG. 6, the reversing roller 39a is rotated clockwise (in a direction for feeding the document sheet to the reverse tray 30). Therefore, the document sheet is fed to the reversing rollers 39a and 39b along the third feeding path d3, and is then fed to the reverse tray 30.

In the process of re-feeding the document sheet fed to the reverse tray 30 to the registration rollers 36a and 36b along the fourth feeding path d4, the rotating direction of the motor 43 is reversed again so that the pinion gear 45 rotates counterclockwise. Accordingly, as illustrated in FIG. 5, the reversing roller 39a rotates counterclockwise (in a switchback direction). At this time, the guide member 41 is moved upward so that the document sheet is fed to the registration rollers 36a and 36b along the fourth feeding path d4 after being switched back. In the state illustrated in FIG. 5, the driving force of the motor 43 is not transmitted to the registration roller 36a. Therefore, the document sheet stops when the document sheet comes into contact with the registration rollers 36a and 36b. The process of secondary feeding from the registration rollers 36a and 36b and the process of discharging the document sheet to the document output tray 32 are similar to the above described case.

In the process of reading the second side using the fourth feeding path d4, the clutch gear 50 is turned off. Therefore, a driving force is not transmitted to either the sheet-feeding roller 34 or the pickup roller 33, and the document sheet that follows is prevented from being fed from the document tray 29.

After the document reading operation is performed for all of the document sheets, the motor 43 is rotated in the reverse direction (direction shown in FIG. 6) and the clutch gear 50 is turned on, so that the sheet-feeding roller 34 rotates in a direction that is opposite to the sheet feeding direction. Accordingly, the arm connected to the rotating shaft of the sheet-feeding roller 34 is lifted upward, and the pickup roller 33 attached to the free end of the arm is moved from the sheet feed position to the home position.

The present invention is not limited to the above-described embodiment, and various modifications are possible within the scope of the present invention. For example, the drive transmission system shown in FIGS. 4 to 6 is merely an example, and the number and arrangement of the gears included in the first drive transmission mechanism and the second drive transmission mechanism can be changed in accordance with the structure of the document feeder 27.

In addition, the arrangement of the clutch gear 50 and the one-way gear 59 is also not limited to the above-described arrangement. For example, the clutch gear 50 is not particularly limited as long as it is provided between the gear connected to the second drive transmission mechanism (the double gear 49 in the above-described example) and the sheet-feeding roller 34 such that the sheet-feeding roller 34 and the pickup roller 33 can be individually controlled. In addition, the one-way gear 59 is also not particularly limited as long as it is located upstream of the registration roller 36a in the direction in which the driving force is transmitted in the second drive transmission mechanism such that the registration roller 36a can be stopped in primary feeding.

The design of other components of the document feeder 27 can also be arbitrarily changed. For example, a sheet-feeding belt may be used in the place of the sheet-feeding roller 34, and a separation roller may be used in the place of the separation pad 35. In addition, in the place of the electromagnetic clutch, the clutch gear 50 may include a mechanical clutch which transmits or cuts off the driving force by using a meshing force between gears, a frictional force between clutch plates, a centrifugal force, or the like.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A document feeder, comprising:
a document feeding means which feeds document sheets stacked on a document tray one at a time;
a registration means which receives each document sheet from the document feeding means and feeds the document sheet to an image reading position at a predetermined timing;
a re-feeding means which receives the document sheet after an image on a first side of the document sheet is read at the image reading position and which re-feeds the document sheet to the registration means in a manner to allow an image on a second side of the document sheet to be read;
a discharging means which discharges the document sheet after an image reading operation performed at the image reading position is completed;
a first drive transmission mechanism and a second drive transmission mechanism wherein a driving force is transmitted to the first drive transmission mechanism and the second drive transmission mechanism from a drive output shaft of a single motor; and
a clutch which is provided in the first drive transmission mechanism at a position upstream of the document feeding means in a direction in which the driving force is transmitted.

2. The document feeder according to claim 1,
wherein the first drive transmission mechanism transmits a driving force to the document feeding means, and the re-feeding means.

3. The document feeder according to claim 1,
wherein the second drive transmission mechanism transmits a driving force to the registration means and the discharging means.

4. The document feeder according to claim 1,
wherein the second drive transmission mechanism is connected to a gear included in the first drive transmission mechanism, and the clutch is located in the first drive transmission mechanism at a position between the document feeding means and a position at which the second drive transmission mechanism is connected to the gear.

5. The document feeder according to claim 1,
wherein the clutch transmits the driving force to the document feeding means when the document sheet is conveyed from the document feeding means to the registration means.

6. The document feeder according to claim 1,
wherein a one-way gear, which transmits the driving force only in a predetermined rotational direction, is provided in the second drive transmission mechanism at a location upstream of the registration means in a direction in which the driving force is transmitted.

7. The document feeder according to claim 1,
wherein the document feeding means includes a feeding means which feeds document sheets stacked on a document tray, the feeding means having a pressure surface which is pressed against a top surface of a topmost document sheet and successively feeds the document sheets by moving the pressure surface in a predetermined direction; and a separating-and-conveying means which separates the document sheets fed by the feeding means from each other and conveys the document sheets one at a time.

8. The document feeder according to claim 7,
wherein the clutch is provided in the first drive transmission mechanism at a position upstream of the separating-and-conveying means in a direction in which the driving force is transmitted.

9. The document feeder according to claim 1,
wherein the re-feeding means includes a reversing means which re-feeds the document sheet to the registration means in a switchback manner.

10. An image forming apparatus, comprising:
a document feeder for feeding document sheets;
an image reading device which reads images on the document sheets;
a sheet feeding mechanism for storing sheets of paper;
a conveying mechanism for conveying the sheets of paper;
an image forming unit for forming a toner image; and
an image transferring unit for transferring the toner image onto a sheet of paper,
wherein the document feeder includes
a feeding means which feeds the document sheets stacked on a document tray, the feeding means having a pressure surface which is pressed against a top surface of a topmost document sheet and successively feeds the document sheets by moving the pressure surface in a predetermined direction,
a separating-and-conveying means which separates the document sheets fed by the feeding means from each other and conveys the document sheets one at a time,
a registration means which receives each document sheet from the separating-and-conveying means and feeds the document sheet to an image reading position at a predetermined timing,
a reversing means which receives the document sheets after an image on a first side of the document sheet is read at the image reading position and which re-feeds the document sheet to the registration means in a switchback manner to allow an image on a second side of the document sheet to be read,
a discharging means which discharges the document sheet after an image reading operation performed at the image reading position is completed,
a first drive transmission mechanism and a second drive transmission mechanism wherein a driving force is transmitted to the first drive transmission mechanism and the second drive transmission mechanism from a drive output shaft of a single motor, and
a clutch which is provided in the first drive transmission mechanism at a position upstream of the separating-and-conveying means in a direction in which the driving force is transmitted.
